(19) United States
(12) Patent Application Publication
(10) Pub. No.: US 2025/0169518 A1
(43) Pub. Date: May 29, 2025

(54) OIL AND/OR FAT COMPOSITION FOR CHOCOLATE

(71) Applicant: FUJI OIL HOLDINGS INC., Osaka (JP)

(72) Inventor: Mai SAKAMOTO, Osaka (JP)

(73) Assignee: FUJI OIL HOLDINGS INC., Osaka (JP)

(21) Appl. No.: 18/843,698

(22) PCT Filed: Feb. 22, 2023
(86) PCT No.: PCT/JP2023/006352

§ 371 Date: Sep. 3, 2024

(30) Foreign Application Priority Data
Mar. 16, 2022 (JP) 2022-040959

(51) Int. Cl. A23G 1/38; A23D 9/02

(52) U.S. Cl. CPC A23G 1/38; A23D 9/02; A23G 2200/08

(57) ABSTRACT

An object is to provide chocolate having a hardness at initial bite, a stickiness resistance, a good flavor, and a bloom resistance, while having a reduced trans fatty acid content. Specific means is to include an oil and/or fat composition for chocolate containing 80 mass % or more of saturated fatty acid content having from 6 to 18 carbons, 30 to 45 mass % of lauric acid content, 0.5 to 5.5 mass % of behenic acid content, 15 mass % or less of unsaturated fatty acid content, 5 mass % or less of trans fatty acid content, in which a palmitic acid/stearic acid ratio is from 0.2 to 2, and an SFC at 10° C. is 90% or more.

### TECHNICAL FIELD

The present invention relates to an oil and/or fat composition for chocolate. More specifically, it relates to an oil and/or fat composition for chocolate, which is suitable for use in chocolate not subjected to a tempering operation.

### BACKGROUND ART

Hard butters widely used as cocoa butter substitutes are roughly classified into tempering type hard butters to be subjected to a temperature control operation at the time of solidification and molding, and non-tempering type hard butters not to be subjected to a temperature control operation. The tempering type hard butters contain a large amount of SUS type triglyceride (S: saturated fatty acid having from 16 to 18 carbons, U: monounsaturated fatty acid having 18 carbons) which is contained in large amount in cocoa butter, and thus, have characteristics and physical properties similar to those of cocoa butter. Therefore, a tempering type hard butter has a high compatibility with cocoa butter, and provides a texture similar to that of cocoa butter. However, it is desirable to skip a tempering operation because it requires a precise temperature control.

On the other hand, a non-tempering type hard butter does not require the complicated tempering operation, and therefore, is capable of being suitably used in various combined food in which chocolate is combined with bread or confectionery. The non-tempering type hard butters can roughly be classified into trans fatty acid type hard butters, interesterified/fractionated type hard butters, and lauric acid type hard butters.

Among the non-tempering type hard butters, trans acid type hard butters obtained by hydrogenating a liquid oil such as soybean oil or rapeseed oil have widely been used for having good meltability in the mouth and high compatibility with cocoa butter. However, in recent years, there are some opinions that the risk on health by trans fatty acid should be reduced, and the market sometimes desires a low trans fatty acid type hard butter which contains no trans fatty acid.

In the demands for low trans acid type hard butter as set forth above, an interesterified/fractionated type hard butter is being developed in recent years (Patent Documents 1 to 4). This interesterified/fractionated type hard butter has a good meltability in the mouth by being produced by chemically or enzymatically interesterifying a raw material oil and/or fat having an extremely low trans fatty acid content, for example, extremely hardened oil of soybean oil or rapeseed oil, or a solid fat such as palm oil, and then performing a fractionation. However, the cost is high due to the complexity of the manufacturing method, and a less expensive hard butter is being desired.

Lauric acid type hard butter has been manufactured for a long time from oil and/or fat rich in triglycerides containing a large amount of lauric acid as a raw material, and examples thereof may include fractionated hard oil of palm kernel oil, and coconut oil. These oils have various advantages such as being capable of providing a texture and physical properties extremely similar to those of cocoa butter, and having a good gloss. However, it is not possible to blend a large amount of cocoa or cocoa butter to these oils, because it causes an intense bloom or graining during storage.

Patent Documents 5 to 9 disclose oil and/or fat compositions for chocolate containing a lauric oil and/or fat having a low trans acid content.

### CITATION LIST

### Patent Documents

Patent Document 1: JP 2005-507028 T

Patent Document 2: JP 2010-532802 T

Patent Document 3: JP 2007-319043 A

Patent Document 4: WO 2011/138918 A

Patent Document 5: JP 2008-182961 A

Patent Document 6: JP 2010-142152 A

Patent Document 7: JP 2010-142153 A

Patent Document 8: JP 2011-115075 A

Patent Document 9: JP 2016-116486 A

### SUMMARY OF INVENTION

### Technical Problem

In recent years, consumer's demands for chocolate have widely varied, and in particular, from an improved health consciousness, chocolate with reduced trans acid is desired. However, at the same time, since importance is also put on chocolate-like texture or taste being maintained, there is a demand for a hard butter which provides a hard texture like that of a tempering chocolate, and which allows flavor of chocolate to be felt abundantly, and a good meltability in the mouth, when chocolate is put in the mouth.

In addition, although it is not just for chocolate, it is also desired to reduce stickiness such as stickiness to hand when food is taken by hand, due to a change in lifestyle. Previous studies have solved a part of the issue by coating chocolate with shellac or the like. However, since an addition of new step makes a process much complex, another solution is required.

The present inventor has studied improvement in quality and function of interesterified oils and/or fats having low trans acid content. Patent Documents 1 to 4 relate to oil and/or fat compositions for chocolate with low trans acid content and no lauric oil and/or fat, which tended to have an inferior meltability in the mouth. Patent Documents 5 to 9 relate to oils and/or fats containing lauric oil and/or fat as a part thereof, which indicated relatively good meltability in the mouth, but cannot be said to be oils and/or fats having all of a hardness at initial bite, a stickiness resistance, a good flavor, and a bloom resistance, at the same time.

In recognition of such known arts, an object of the present invention is to provide an oil and/or fat composition for chocolate which has a reduced trans fatty acid content and yet has a hardness at initial bite, a stickiness resistance, a good flavor, and a bloom resistance with a simple method.

### Solution To Problem

As a result of intensive studies to solve the above issue, the present inventor has found that an oil and/or fat composition for chocolate having a randomized triglyceride composition with a specific fatty acid composition can solve the above issue, and has completed the present invention.

That is, the present invention includes the following inventions:

(1) An oil and/or fat composition for chocolate containing a randomized triglyceride composition and satisfying all of (A) to (H):
(A) a content of a saturated fatty acid having from 6 to 18 carbons is 80 mass % or more in a constituent fatty acid composition;
(B) a content of lauric acid is from 30 to 45 mass % in a constituent fatty acid composition;
(C) a content of behenic acid is from 0.5 to 5.5 mass % in a constituent fatty acid composition;
(D) a content of an unsaturated fatty acid is 15 mass % or less in a constituent fatty acid composition;
(E) a content of a trans fatty acid is 5 mass % or less in a constituent fatty acid composition;
(F) a palmitic acid content/stearic acid content ratio is from 0.2 to 2 in a constituent fatty acid composition;
(G) an unsaturated fatty acid content/behenic acid content ratio is 4 or less in a constituent fatty acid composition; and
(H) an SFC at 10° C. is 90% or more.

(2) The oil and/or fat composition for chocolate of (1), further containing an extremely hardened high-erucic-acid rapeseed oil.

(3) The oil and/or fat composition for chocolate of (1) or (2), wherein a slope from the SFC at 10° C. to the SFC at 40° C. is −3.1 or less,
where a slope per temperature based on an SFC % at 10° C. to 40° C. is obtained from a rate of change (slope) per temperature corresponding to a coefficient of X of a supposed linear function (X-axis represents temperature and Y-axis represents SFC %) connecting six points of 10° C. SFC %, 20° C. SFC %, 25° C. SFC %, 30° C. SFC %, 35° C. SFC % and 40° C. SFC %.

(4) The oil and/or fat composition for chocolate of (1), wherein an SFC at 35° C. is 15% or less, and an SFC at 40° C. is 5% or less.

(5) The oil and/or fat composition for chocolate of (2), wherein an SFC at 35° C. is 15% or less, and an SFC at 40° C. is 5% or less.

(6) The oil and/or fat composition for chocolate of (3), wherein an SFC at 35° C. is 15% or less, and an SFC at 40° C. is 5% or less.

(7) A method for manufacturing the oil and/or fat composition for chocolate of (1), the method including a step of interesterifying a raw material oil and/or fat containing, as essential components, the following oil and/or fat component X, oil and/or fat component Y, and oil and/or fat component Z:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof.
the oil and/or fat component Z is an extremely hardened high-erucic-acid rapeseed oil.

(8) A method for manufacturing the oil and/or fat composition for chocolate of (2), the method including a step of interesterifying a raw material oil and/or fat containing, as essential components, the following oil and/or fat component X, oil and/or fat component Y, and oil and/or fat component Z:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof.
the oil and/or fat component Z is an extremely hardened high-erucic-acid rapeseed oil.

(9) A method for manufacturing the oil and/or fat composition for chocolate of (3), the method including a step of interesterifying a raw material oil and/or fat containing, as essential components, the following oil and/or fat component X, oil and/or fat component Y, and oil and/or fat component Z:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof.
the oil and/or fat component Z is an extremely hardened high-erucic-acid rapeseed oil.

(10) The method for manufacturing the oil and/or fat composition for chocolate of (4), the method including a step of interesterifying a raw material oil and/or fat containing, as essential components, the following oil and/or fat component X, oil and/or fat component Y, and oil and/or fat component Z:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof.
the oil and/or fat component Z is an extremely hardened high-erucic-acid rapeseed oil.

(11) A method for manufacturing the oil and/or fat composition for chocolate of (1), the method including a step of interesterifying a raw material oil and/or fat containing, as essential components, the following oil and/or fat component X, oil and/or fat component Y, and oil and/or fat component Z:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

(12) The method for manufacturing the oil and/or fat composition for chocolate of (2), the method including a step of interesterifying a raw material oil and/or fat containing, as essential components, the following oil and/or fat component X, oil and/or fat component Y, and oil and/or fat component Z:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

(13) A method for manufacturing the oil and/or fat composition for chocolate of (3), the method including a step of interesterifying a raw material oil and/or fat containing, as essential components, the following oil and/or fat component X, oil and/or fat component Y, and oil and/or fat component Z:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

(14) A method for manufacturing the oil and/or fat composition for chocolate of (4), the method including a step of interesterifying a raw material oil and/or fat containing, as essential components, the following oil and/or fat component X, oil and/or fat component Y, and oil and/or fat component Z:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

(15) A chocolate containing the oil and/or fat composition for chocolate of (1).

(16) A chocolate containing the oil and/or fat composition for chocolate of (2).

(17) A chocolate containing the oil and/or fat composition for chocolate of (3).

(18) A chocolate containing the oil and/or fat composition for chocolate of (4).

In other words, the present invention includes the following inventions:

(1) An oil and/or fat composition for chocolate, containing a randomized triglyceride composition and satisfying all of (A) to (H):
(A) a content of a saturated fatty acid having from 6 to 18 carbons is 80 mass % or more in a constituent fatty acid composition;
(B) a content of lauric acid is from 30 to 45 mass % in a constituent fatty acid composition;
(C) a content of behenic acid is from 0.5 to 5.5 mass % in a constituent fatty acid composition;
(D) a content of an unsaturated fatty acid is 15 mass % or less in a constituent fatty acid composition;
(E) a content of a trans fatty acid is 5 mass % or less in a constituent fatty acid composition;
(F) a palmitic acid content/stearic acid content ratio is from 0.2 to 2 in a constituent fatty acid composition;
(G) an unsaturated fatty acid content/behenic acid content ratio is 4 or less in a constituent fatty acid composition; and
(H) an SFC at 10° C. is 90% or more.

(2) The oil and/or fat composition for chocolate of (1), further containing an extremely hardened high-erucic-acid rapeseed oil.

(3) The oil and/or fat composition for chocolate of (1) or (2), wherein a slope from the SFC at 10° C. to the SFC at 40° C. is −3.1 or less,
where a slope per temperature based on an SFC % at 10° C. to 40° C. can be obtained from a rate of change (slope) per temperature corresponding to a coefficient of X of a supposed linear function (X-axis represents temperature and Y-axis represents SFC %) connecting six points of 10° C. SFC %, 20° C. SFC %, 25° C. SFC %, 30° C. SFC %, 35° C. SFC % and 40° C. SFC %.

(4) The oil and/or fat composition for chocolate of (1) to (3), wherein an SFC at 35° C. is 15% or less, and an SFC at 40° C. is 5% or less.

(5) A method for manufacturing the oil and/or fat composition for chocolate of (1) to (4), the method including a step of interesterifying a raw material oil and/or fat containing, as essential components, the following oil and/or fat component X, oil and/or fat component Y, and oil and/or fat component Z:

The oil and/or fat component X is one or more kinds of oils and/or fats selected from palm kernel oil and a processed oil and/or fat thereof;

The oil and/or fat component Y is one or more kinds of oils and/or fats selected from palm oil and a processed oil and/or fat thereof.

The oil and/or fat component Z is an extremely hardened high-erucic-acid rapeseed oil. (6) A chocolate containing the oil and/or fat composition for chocolate of (1) to (4).

### Advantageous Effect of Invention

According to the present invention, it is possible to obtain an oil and/or fat composition for chocolate having a hardness at initial bite, a stickiness resistance, a good flavor, and a bloom resistance.

As a preferred embodiment, use of the oil and/or fat composition for chocolate of the present invention in chocolate allows manufacturing chocolate which does not require a tempering operation and which has a hardness at initial bite, a stickiness resistance, a good flavor, and a bloom resistance, while achieving a reduction of trans fatty acid content.

### DESCRIPTION OF EMBODIMENT

Hereinbelow, the present invention will be described in detail.

In the oil and/or fat composition for chocolate of the present invention, a content of saturated fatty acids having from 6 to 18 carbons in a constituent fatty acid composition needs to be 80 mass % or more, preferably 81 to 96 mass %, and more preferably 82 to 94 mass %. When the content of saturated fatty acids having from 6 to 18 carbons is below 80 mass %, an amount of the triglyceride having a low melting point is large, and the hardness at initial bite may not be obtained.

In the oil and/or fat composition for chocolate of the present invention, a content of lauric acid in a constituent fatty acid composition needs to be 30 to 45 mass %, preferably 31 to 44 mass %, more preferably 32 to 43 mass %, even more preferably 33 to 42 mass %, and most preferably 33 to 41 mass %. When a content of lauric acid is below 30 mass %, a content of palmitic acid or stearic acid in the saturated fatty acid is relatively increased, deteriorating the meltability in the mouth, and the good flavor may not be obtained. When a content of lauric acid exceeds 45 mass %, a content of palmitic acid or stearic acid in the saturated fatty acid relatively decreases, an SFC % at 10° C. lowers, and the hardness at initial bite may not be obtained.

In the oil and/or fat composition for chocolate of the present invention, a content of behenic acid in a constituent fatty acid composition needs to be 0.5 to 5.5 mass %, preferably 1.5 to 5.5 mass %, more preferably 2.5 to 5.5 mass %, even more preferably 3.5 to 5.5 mass %, and most preferably 4 to 5.5 mass %. When a content of behenic acid is below 0.5 mass %, the compatibility with a cocoa butter is lowered and the bloom resistance may be weakened. When a content of behenic acid exceeds 5.5 mass %, an amount of triglyceride having a high melting point increases, and the meltability in the mouth may be deteriorated.

In the oil and/or fat composition for chocolate of the present invention, a content of an unsaturated fatty acid in a constituent fatty acid composition needs to be 15 mass % or less, preferably 14 mass % or less, more preferably 13 mass % or less, even more preferably 12.5 mass % or less, and most preferably 12 mass % or less. When the unsaturated fatty acid content exceeds 15 mass %, the triglyceride having a low melting point increases, which may lead to a stickiness when the oil and/or fat is blended in chocolate. The reason for this is considered that a part of the oil and/or fat is present in a molten state at room temperature to increase the adhesiveness, although it is a presumption.

In the oil and/or fat composition for chocolate of the present invention, a content of a trans fatty acid in a constituent fatty acid composition needs to be 5 mass % or less, preferably 4 mass % or less, more preferably 3 mass % or less, even more preferably 2 mass % or less, and most preferably 1 mass % or less.

In the oil and/or fat composition for chocolate of the present invention, a palmitic acid/stearic acid ratio needs to be 0.2 to 2, preferably 0.25 to 1.7, more preferably 0.3 to 1.5, and even more preferably 0.35 to 1.2, in a constituent fatty acid composition. When the palmitic acid/stearic acid ratio is below 0.2, a relative amount of stearic acid to palmitic acid increases, deteriorating the meltability in the mouth and the good flavor cannot be obtained, which is not desirable. When the palmitic acid/stearic acid ratio exceeds 2, a relative amount of stearic acid to palmitic acid decreases, lowering the SFC % at 10° C., and the hardness at initial bite may not be obtained.

In the oil and/or fat composition for chocolate of the present invention, a ratio of unsaturated fatty acid content/behenic acid in a constituent fatty acid composition needs to be 4 or less, preferably 3 or less. When the unsaturated fatty acid content/behenic acid ratio is below 4, a relative amount of the unsaturated fatty acid to the behenic acid increases, and the good flavor may not be obtained.

The oil and/or fat composition for chocolate of the present invention needs to have an SFC at 10° C. of 90% or more, preferably from 90 to 97%, and more preferably from 91 to 95%. When an SFC % at 10° C. is below 90%, the hardness at initial bite may not be obtained.

In the oil and/or fat composition for chocolate of the present invention, a slope per temperature based on the SFC % at 10° C. to 40° C. is preferably −3.1 or less, and more preferably −3.2 or less. When the slope exceeds −3.1, the hardness at initial bite and a good flavor may not be obtained at the same time.

In this connection, the slope per temperature based on the SFC % at 10° C. to 40° C. can be obtained from a rate of change (slope) per temperature corresponding to a coefficient of X of a supposed linear function (X-axis represents temperature and Y-axis represents SFC %) connecting six points of 10° C. SFC %, 20° C. SFC %, 25° C. SFC %, 30° C. SFC %, 35° C. SFC % and 40° C. SFC %. The slope may be calculated using a general spreadsheet software. In addition, validity of an obtained value of the slope is confirmed by checking if a simultaneously obtained determination coefficient value (R2) exceeds at least 0.8.

The oil and/or fat composition for chocolate of the present invention preferably has an SFC at 35° C. of 15% or less, and at the same time an SFC at 40° C. of 5% or less, more preferably an SFC at 35° C. of 14% or less and at the same time an SFC at 40° C. of 3% or less. When the SFC at 35° C. exceeds 15%, and at the same time the SFC at 40° C. exceeds 5%, the meltability in the mouth may be deteriorated and the good flavor may not be obtained.

The hardness at initial bite as used herein refers to a hardness in texture of chocolate when eaten, and can be indicated in a breaking load as an oil and/or fat analysis value. The higher the value of a breaking load is, the more excellent in the hardness at initial bite an oil and/or fat can be.

Similarly, the stickiness as used herein refers to a degree of adhesiveness of chocolate when touched, and can be indicated in an adhesiveness property as an oil and/or fat analysis value. The lower the adhesiveness value is, the less sticky an oil and/or fat can be.

Examples of an oil and/or fat which can be used in the oil and/or fat composition for chocolate of the present invention may include vegetable oils and/or fats such as high-erucic-acid rapeseed oil, rapeseed oil (canola oil), soybean oil, sunflower seed oil, cottonseed oil, peanut oil, rice bran oil, corn oil, safflower oil, olive oil, kapok oil, sesame oil, evening primrose oil, palm oil, palm kernel oil, coconut oil, medium-chain fatty acid-conjugated triglycerides (MCT), shea fat, and sal fat, animal oils and/or fats such as milk fat, beef fat, lard, fish oil and whale oil, and hardened oil, fractionated oil, hardened fractionated oil, fractionated hardened oil, and processed oils and/or fats subjected to an interesterification thereof, and mixed oils and/or fats thereof.

Although an oil and/or fat to be used in the oil and/or fat composition for chocolate of the present invention is not particularly limited, as long as the above-described constitution is satisfied, it is preferable to use a raw material oil and/or fat containing, as essential components, the following oil and/or fat component X, oil and/or fat component Y, and oil and/or fat component Z.
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof.

The oil and/or fat component Z is an extremely hardened high-erucic-acid rapeseed oil;

The oil and/or fat composition for chocolate of the present invention is more preferably used as a raw material oil and/or fat containing, as essential components, the following oil and/or fat component X, oil and/or fat component Y, and oil and/or fat component Z:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;

The oil and/or fat component Z is an extremely hardened high-erucic-acid rapeseed oil;

The oil and/or fat composition for chocolate of the present invention has a randomized triglyceride composition prepared to have the above-described oil and/or fat composition. Examples of manufacturing method may include a method of performing a random interesterification, and a method of performing a random interesterification followed by an extreme hydrogenation.

In the present specification, the randomized triglyceride composition is obtained by random interesterification in which fatty acids are once cut off from triglyceride by a chemical catalyst or an enzyme catalyst and then recombined. Therefore, the manner of distribution of the fatty acids to the 1- to 3-positions depending on kind of the fatty acids is completely random and is stochastically and uniquely determined. This is preferable because, it is possible to obtain more types of triglyceride, allowing an untempered chocolate to have an excellent stabilization of quality over a long term.

The randomized triglyceride composition is contained preferably 70 mass % or more, more preferably 90 mass % or more, still more preferably 98 mass % or more, and most preferably 99 mass % or more with respect to the whole oil and/or fat composition for chocolate of the present invention. When the content of the randomized triglyceride composition is less than 70 mass % relative to the total amount of the oil and/or fat composition for chocolate of the present invention, the number of kinds of triglycerides is not be sufficient, which may cause an insufficient bloom resistance.

The oil and/or fat composition for chocolate of the present invention can also be obtained by performing an extreme hydrogenation after performing a random interesterification. An oil and/or fat to be extremely hardened is obtained by converting double bonds included in a vegetable oil and/or fat into single bonds by hydrogenation with a chemical catalyst containing nickel as a main component. As used herein, an oil and/or fat which has been hardened to 4 or less of iodine value which is an indicator of degree of unsaturation, is defined as an extremely hardened oil and/or fat.

The oil and/or fat composition for chocolate of the present invention may contain a small amount of extremely hardened high-erucic-acid rapeseed oil, in addition to the randomized triglyceride composition. By blending in a small amount of extremely hardened high-erucic-acid rapeseed oil, it is possible to improve a bloom resistance while maintaining a hardness at initial bite, a stickiness resistance and a good flavor.

The erucic acid content in the high-erucic-acid rapeseed oil used in preparing an extremely hardened high-erucic-acid rapeseed oil is preferably 30 mass % or more in a constituent fatty acid composition.

The proportion of the extremely hardened high-erucic-acid rapeseed oil in the oil and/or fat composition for chocolate of the present invention is preferably 2 mass % or less, more preferably 1 mass % or less, and still more preferably 0.6 mass % or less. When a proportion of the small amount of extremely hardened high-erucic-acid rapeseed oil to the randomized triglyceride composition exceeds 2 mass %, a good flavor may not be obtained since amount of the high melting point component is large.

A use amount of the oil and/or fat composition for chocolate of the present invention is preferably from 10 to 65 mass %, more preferably from 10 to 50 mass %, and even more preferably from 15 to 45 mass % with respect to the whole chocolate. When a content of the oil and/or fat composition for chocolate of the present invention is less than 10 mass %, the characteristics such as the hardness at initial bite and the reduction of stickiness required in the chocolate found in the present invention may not be obtained. When the content exceeds 65 mass %, the good flavor may not be obtained, although the above-described properties are obtained, and chocolate has a relatively increased oil content, causing the chocolate an oily feeling, which is not preferable.

Incidentally, when preparing chocolate of the present invention, it is possible to add another oil and/or fat, as long as the oil and/or fat composition for chocolate of the present invention is used as an essential component.

The term chocolate as used herein is not limited to chocolate, quasi chocolate and chocolate-utilizing food defined by the Japan Fair Trade Council of Chocolate Industry and the Japan Fair Trade Council of Chocolate-Utilizing Foods, but also entails oil and/or fat-processed food which contains oil and/or fat as an essential component and is produced by using cocoa mass, cocoa, cocoa butter, cocoa butter equivalent fat, hard butter or the like.

A general method for manufacturing chocolate may be used as a manufacturing method of the chocolate using the oil and/or fat composition for chocolate of the present invention. Specifically, it is possible to obtain chocolate by essentially including the oil and/or fat composition for chocolate of the present invention, appropriately selecting raw materials such as: powder foods such as sugar, cocoa mass, cocoa butter, cocoa powder, and milk powder; emulsifier; flavor; and colorant, that are mixed with each other, and then subjected to a roll-refining and a conching process.

In the chocolate using the oil and/or fat composition for chocolate of the present invention, it is possible to use an emulsifier which is usually used in a manufacture of chocolate.

Examples thereof may include glycerin fatty acid ester, sucrose fatty acid ester, organic acid monoglycerin fatty acid ester, polysorbate, polyglycerin condensed ricinoleic acid ester, and sorbitan fatty acid ester. These may be used alone, or may be used in combination of two or more thereof.

### EXAMPLES

Hereinbelow, the present invention will be described more in detail, by showing Examples. Incidentally, in the examples, both % and parts are meant to be on mass basis.

### Example 1

A raw material oil and/or fat prepared by blending 35 mass % of palm kernel oil, 38 mass % of extremely hardened palm kernel oil, 15 mass % of high melting point part of fractionated palm (iodine value 31), 2 mass % of extremely hardened palm oil, and 10 mass % of extremely hardened high-erucic-acid rapeseed oil, was added with 0.2 mass % of sodium methylate as a catalyst and the resultant was subjected to a random interesterification at 80° C. for 30 minutes, followed by washing with water, decoloring, and deodorization in a conventional manner.

### Example 2

A raw material oil and/or fat prepared by blending 15 mass % of palm kernel oil, 57 mass % of extremely hardened palm kernel oil, 15 mass % of high melting point part of fractionated palm (iodine value of 31), 3 mass % of extremely hardened palm oil, 10 mass % of extremely hardened high-erucic-acid rapeseed oil, was added with 0.2 mass % of sodium methylate as a catalyst, and the resultant was subjected to a random interesterification at 80° C. for 30 minutes, followed by washing with water, decoloring, and deodorization in a conventional manner.

### Example 3

A raw material oil and/or fat prepared by blending 69 mass % of palm kernel oil, 24 mass % of extremely hardened palm oil, and 7 mass % of extremely hardened high-erucic-acid rapeseed oil, was added with and 0.2 mass % of sodium methylate as a catalyst, and the resultant was subjected to a random interesterification at 80° C. for 30 minutes, followed by washing with water, decoloring, and deodorization in a conventional manner.

### Example 4

A raw material oil and/or fat prepared by blending 85.5 mass % of palm kernel oil, 4.5 mass % of palm oil, 10 mass % of extremely hardened high-erucic-acid rapeseed oil, was added with 0.2 mass % of sodium methylate as a catalyst, and the resultant was subjected to a random interesterification at 80° C. for 30 minutes, followed by washing with water, and further added with 0.2 mass % of nickel catalyst (SO-750 manufactured by SAKAI CHEMICAL INDUSTRY CO., LTD.), and the resultant was cured at a hydrogenation pressure of 0.26 MPa and at a temperature with an upper limit of 180° C. until an iodine value reached 1 or less, followed by decoloration/deodorization in a conventional manner. The obtained 99.6 mass % deodorized oil was further added with 0.4 mass % of extremely hardened high-erucic-acid rapeseed oil. Ratio of the extremely hardened high-erucic-acid rapeseed oil to the deodorized oil having a randomized triglyceride composition is 0.4 mass %.

### Comparative Example 1

A raw material oil and/or fat prepared by blending 55 mass % of palm kernel oil, 35 mass % of high melting point part of fractionated palm (iodine value of 31), 10 mass % of extremely hardened high-erucic-acid rapeseed oil, was added with 0.2 mass % of sodium methylate as a catalyst, and the resultant was subjected to a random interesterification at 80° C. for 30 minutes, followed by washing with water, decoloring, and deodorization in a conventional manner.

### Comparative Example 2

A raw material oil and/or fat prepared by blending 45 mass % of high melting point part of fractionated palm kernel oil (iodine value of 7), 45 mass % of high melting point part of fractionated palm (iodine value of 31), and 10 mass % of high melting point part of fractionated palm (iodine value of 12), was added with 0.2 mass % of sodium methylate as a catalyst, and the resultant was subjected to a random interesterification at 80° C. for 30 minutes, followed by washing with water, decoloring, and deodorization in a conventional manner.

### Comparative Example 3

A raw material oil and/or fat prepared by blending 61 mass % of high melting point part of fractionated palm (iodine value of 31), 36 mass % of palm oil and 3 mass % of extremely hardened high-erucic-acid rapeseed oil, was added with 0.2 mass % of sodium methylate as a catalyst, and the resultant was subjected to a random interesterification at 80° C. for 30 minutes, followed by washing with water, decoloring, and deodorization in a conventional manner.

### Comparative Example 4

A raw material oil and/or fat prepared by blending 50 mass % of coconut oil, 40 mass % of high melting point part of fractionated palm (iodine value of 31), 10 mass % of extremely hardened high-erucic-acid rapeseed oil, was added with 0.2 mass % of sodium methylate as a catalyst, and the resultant was subjected to a random interesterification at 80° C. for 30 minutes, followed by washing with water, decoloring, and deodorization in a conventional manner. The obtained 99.6 mass % deodorized oil was further added with 0.4 mass % of extremely hardened high-erucic-acid rapeseed oil. Ratio of the extremely hardened high-erucic-acid rapeseed oil to the deodorized oil having a randomized triglyceride composition is 0.4 mass %.

### Method for Measuring Fatty Acid Composition

The constituent fatty acid compositions of the oils and/or fats were measured in accordance with Standard Methods for Analysis of Fats, Oils and Related Materials 2.4.2.1-2013.

### Method for Measuring SFC

As an analyzer, “minispecmq20” manufactured by Bruker was used. SFC measurement was performed in accordance with IUPAC 2.150a (Solid Content Determination in Fats by NMR). (Method for measuring breaking load at 10° C.)

As an analyzer, a creep meter (RE2-33005 C) manufactured by Yamaden Co., Ltd. was used. Before the measurement, an oil and/or fat sample filled to make 7 mm thickness into an aluminum cup with a diameter of about 25 mm was cooled at 5° C. for 30 minutes, stored at 15° C. for one day, and then temperature-controlled at 10° C. for 4 hours. The measurement was performed at a measurement rate of 1 mm/sec and a measurement distortion rate of 90%, with a cylindrical plunger (diameter 3 mm) led to the center of the samples. As a road cell for applying a load, a road cell for 20 kgf was used. The number of measurement points was six, and the average value of the measurement points was indicated. A point at which a change in the load was first observed, clearly due to a breaking, was taken as a breaking point. (Method for measuring 25° C. adhesiveness)

As an analyzer, a creep meter (RE2-33005 C) manufactured by Yamaden Co., Ltd. was used. Before the measurement, an oil and/or fat sample filled to make 7 mm thickness into an aluminum cup with a diameter of about 25 mm was cooled at 5° C. for 30 minutes, stored at 15° C. for one day, and then temperature-controlled at 25° C. for four hours. The measurement was performed at a measurement rate of 5 mm/sec, a measurement distortion rate of 50%, and a return distance of 5 mm, with a cylindrical plunger (diameters 8 mm) led to the centers of the samples twice in repetition. As a road cell for applying a load, a road cell for 20 kgf was used. The number of measurement points was six, and the average value of the measurement points was indicated.

Table 1 indicates results of measuring fatty acid compositions and SFCs, according to the method for measuring fatty acid composition and the method for measuring SFC set forth above.

Incidentally, in the column of “slope per temperature based on SFC % at 10° C. to 40° C. [-]”, the upper section indicates values of the slopes, and the lower section (in parentheses) indicates determination coefficient values (R2).

TABLE 1

| | | Example | Example | Example | Example | Comparative | Comparative | Comparative | Comparative |
|---|---|---|---|---|---|---|---|---|---|
| Product name | | 1 | 2 | 3 | 4 | Example 1 | Example 2 | Example 3 | Example 4 |
| Iodine value | | 10.9 | 7.5 | 13.0 | 0.4 | 20.5 | 18.7 | 38.2 | 17.5 |
| Fatty acid | C6:0 | 0.1 | 0.1 | 0.0 | 0.0 | 0.0 | 0.0 | 0.0 | 0.0 |
| composition % | C8:0 | 2.2 | 2.1 | 2.1 | 2.5 | 1.4 | 0.7 | 0.0 | 2.5 |
| | C10:0 | 2.2 | 2.2 | 2.1 | 2.6 | 1.6 | 1.1 | 0.0 | 2.5 |
| | C12:0 | 34.8 | 34.0 | 33.5 | 40.5 | 25.4 | 24.0 | 0.3 | 22.8 |
| | C14:0 | 11.9 | 11.7 | 11.4 | 13.7 | 9.2 | 10.5 | 1.1 | 9.6 |
| | C16:0 | 17.2 | 17.8 | 16.4 | 9.2 | 29.6 | 41.6 | 53.2 | 32.9 |
| | C16:1 | 0.0 | 0.0 | 0.0 | 0.0 | 0.1 | 0.0 | 0.2 | 0.0 |
| | C18:0 | 14.9 | 19.0 | 17.4 | 24.8 | 7.2 | 3.8 | 5.9 | 7.7 |
| | C18:1t | 0.0 | 0.0 | 0.0 | 0.0 | 0.1 | 0.0 | 0.1 | 0.0 |
| | C18:1c | 9.4 | 6.2 | 10.8 | 0.0 | 17.0 | 14.8 | 30.0 | 13.7 |
| | C18:2t | 0.0 | 0.0 | 0.0 | 0.0 | 0.0 | 0.2 | 0.3 | 0.0 |
| | C18:2c | 1.7 | 1.2 | 1.7 | 0.0 | 3.2 | 3.1 | 6.7 | 2.8 |
| | C18:3t | 0.0 | 0.0 | 0.0 | 0.0 | 0.0 | 0.0 | 0.0 | 0.0 |
| | C18:3c | 0.0 | 0.0 | 0.0 | 0.0 | 0.0 | 0.0 | 0.0 | 0.0 |
| | C20:0 | 1.1 | 1.1 | 0.8 | 1.1 | 0.8 | 0.2 | 0.7 | 1.0 |
| | C20:1 | 0.0 | 0.0 | 0.0 | 0.0 | 0.0 | 0.0 | 0.0 | 0.0 |
| | C22:0 | 4.6 | 4.6 | 3.3 | 4.8 | 4.5 | 0.0 | 1.4 | 4.5 |
| | C24:0 | 0.0 | 0.0 | 0.0 | 0.0 | 0.0 | 0.0 | 0.0 | 0.0 |
| SFC % | 10° C. | 91.4 | 94.1 | 91.1 | 95.1 | 84.3 | 90.2 | 82.6 | 84.4 |
| | 20° C. | 70.0 | 78.4 | 69.1 | 85.6 | 60.2 | 75.1 | 65.2 | 60.0 |
| | 25° C. | 51.4 | 62.0 | 51.5 | 69.6 | 42.9 | 59.4 | 54.0 | 43.7 |
| | 30° C. | 26.9 | 38.6 | 28.3 | 44.4 | 22.2 | 40.9 | 41.3 | 24.0 |
| | 35° C. | 5.9 | 13.5 | 8.1 | 13.5 | 5.9 | 19.3 | 29.7 | 8.2 |
| | 40° C. | 0.3 | 0.2 | 0.0 | 2.5 | 0.0 | 3.8 | 19.5 | 0.3 |
| | Slope per | −3.3 | −3.3 | −3.3 | −3.4 | −3.0 | −3.0 | −2.2 | −3.0 |
| | temperature | (0.9738) | (0.958) | (0.9801) | (0.9203) | (0.985) | (0.9649) | (0.9953) | (0.99) |
| | based on | | | | | | | | |
| | SFC % at | | | | | | | | |
| | 10° C. to | | | | | | | | |
| | 40° C. | | | | | | | | |
| | [—] | | | | | | | | |

### Evaluation Criteria for Fatty Acid Composition and SFC Measurement Values

Evaluation was made with the following numerical values (A) to (H). Table 2 indicates results of the evaluation.
(A) a content of a saturated fatty acid having from 6 to 18 carbons is 80 mass % or more in a constituent fatty acid composition;
(B) a content of lauric acid is from 30 to 45 mass % in a constituent fatty acid composition;
(C) a content of behenic acid is from 0.5 to 5.5 mass % in a constituent fatty acid composition;
(D) a content of an unsaturated fatty acid is 15 mass % or less in a constituent fatty acid composition;
(E) a content of a trans fatty acid is 5 mass % or less in a constituent fatty acid composition;
(F) a palmitic acid/stearic acid ratio is 0.2 to 2 in a constituent fatty acid composition;
(G) an unsaturated fatty acid content/behenic acid content ratio is 4 or less in a constituent fatty acid composition;
(H) an SFC at 10° C. is 90% or more;

TABLE 2

| | Example | Example | Example | Example | Comparative | Comparative | Comparative | Comparative |
|---|---|---|---|---|---|---|---|---|
| | 1 | 2 | 3 | 4 | Example 1 | Example 2 | Example 3 | Example 4 |
| (A) Saturated fatty acid | 83.3 | 86.9 | 82.9 | 93.3 | 74.4 | 81.7 | 60.5 | 78.0 |
| content having from 6 to | | | | | | | | |
| 18 carbons (mass %) | | | | | | | | |
| (B) Lauric acid content | 34.8 | 34.0 | 33.5 | 40.5 | 25.4 | 24.0 | 0.3 | 22.8 |
| (mass %) | | | | | | | | |
| (C) Behenic acid content | 4.6 | 4.6 | 3.3 | 4.8 | 4.5 | 0.0 | 1.4 | 4.5 |
| (mass %) | | | | | | | | |
| (D) Unsaturated fatty | 11.1 | 7.4 | 12.5 | 0.0 | 20.4 | 18.1 | 37.4 | 16.5 |
| acid content (mass %) | | | | | | | | |
| (E) Trans fatty acid | 0.0 | 0.0 | 0.0 | 0.0 | 0.1 | 0.2 | 0.5 | 0.0 |
| content (mass %) | | | | | | | | |
| (F) Palmitic acid | 1.2 | 0.9 | 0.9 | 0.4 | 4.1 | 11.0 | 9.0 | 4.3 |
| content/stearic acid | | | | | | | | |
| content ratio | | | | | | | | |
| (G) Unsaturated fatty | 2.4 | 1.6 | 3.8 | 0.0 | 4.5 | — | 26.7 | 3.7 |
| acid content/behenic | | | | | | | | |
| acid content ratio | | | | | | | | |
| (H) SFC at 10° C. (%) | 91.4 | 94.1 | 91.1 | 95.1 | 84.3 | 90.2 | 82.6 | 84.4 |

### Discussion on Fatty Acid Compositions and SFC Measurement Values in Table 2

Example 1 to Example 4 satisfied all of the numerical ranges of (A) to (H).
Comparative Example 1 did not satisfy (A), (B), (D), (F), (G), and (H).
Comparative Example 2 did not satisfy (B), (C), (D), (G) and (H).
Comparative Example 3 did not satisfy (A), (B), (D), (F), (G), and (H).
Comparative Example 4 did not satisfy (A), (B), (D), (F), and (H).

### Evaluation Criteria for 10° C. Breaking Load and 25° C. Adhesiveness

Table 3 indicates results of measuring 10° C. breaking load and 25° C. adhesiveness according to the method for measuring 10° C. breaking load and the method for measuring 25° C. adhesiveness set forth above.

The breaking load is an example index to indicate hardness of food, and the larger a numerical value, the better the hardness at initial bite. Breaking load at 10° C. of 3 kgf or more were judged as good.

Adhesiveness is an example index to indicate how a food easily adheres, and the smaller a numerical value, the less the adhesiveness to finger. Adhesiveness at 25° C. of 1.5 J/m3 or less was judged as good.

TABLE 3

| | Example | Example | Example | Example | Comparative | Comparative | Comparative | Comparative |
|---|---|---|---|---|---|---|---|---|
| Product name | 1 | 2 | 3 | 4 | Example 1 | Example 2 | Example 3 | Example 4 |
| 10° C. breaking | 3.7 | 4.5 | 3.6 | 5.9 | 2.8 | 2.8 | 2.4 | 2.7 |
| load [kgf] | | | | | | | | |
| 25° C. adhesiveness | 1.0 | 1.2 | 1.5 | 1.3 | 1.8 | 1.6 | 2.3 | 3.6 |
| [kJ/m³] | | | | | | | | |

### Discussion on 10° C. Breaking Load and 25° C. Adhesiveness in Table 3

Example 1 to Example 4 satisfied both of the evaluation criteria for 10° C. breaking load and 25° C. adhesiveness.

Comparative Examples 1 to 4 satisfied neither the evaluation criteria for 10° C. breaking load nor 25° C. adhesiveness.

### Evaluation of Oil and/or Fat Composition for Chocolate by Chocolate Test

The oil and/or fat compositions for chocolate produced above, Examples 1 to 4, and Comparative Examples 1 to 4 were used and evaluated by a chocolate test.

Using the oil and/or fat compositions for chocolate as the vegetable oil and/or fat part of Table 4, chocolates were produced according to the formulations. In the blended raw materials, the whole milk powder contains 26% of milk fat and the cocoa mass contains 55% of cocoa butter, and therefore, oil content of the present chocolate is 44.1%. In the oil content, contents of cocoa butter, milk fat, and vegetable oil and/or fat are calculated to be 10.0%, 11.8%, and 78.2%, respectively.

The prepared chocolates were completely melted, then cooled to 45° C., poured into aluminum cups, cooled at 5° C. for 30 minutes, and subjected to sensory evaluation by three panelists who made evaluation by consultation in accordance with the following evaluation criteria. Table 5 indicates results of the evaluation.

TABLE 4

| | | Example | Example | Example | Example | Comparative | Comparative | Comparative | Comparative |
|---|---|---|---|---|---|---|---|---|---|
| Chocolate | | 5 | 6 | 7 | 8 | Example 5 | Example 6 | Example 7 | Example 8 |
| Sugar | | 37.2 | | | | | | | |
| Vegetable | Example 1 | 34.5 | | | | | | | |
| oil and/or | Example 2 | | 34.5 | | | | | | |
| fat | Example 3 | | | 34.5 | | | | | |
| | Example 4 | | | | 34.5 | | | | |
| | Comparative | | | | | 34.5 | | | |
| | Example 1 | | | | | | | | |
| | Comparative | | | | | | 34.5 | | |
| | Example 2 | | | | | | | | |
| | Comparative | | | | | | | 34.5 | |
| | Example 3 | | | | | | | | |
| | Comparative | | | | | | | | 34.5 |
| | Example 4 | | | | | | | | |

| | |
|---|---|
| Whole milk powder | 19.9 |
| Cocoa mass | 8.0 |
| Lecithin | 0.4 |

### Evaluation Criteria for Hardness at Initial Bite

Hardness at initial bite of the produced chocolates were evaluated in accordance with the following evaluation criteria. 2 points or more were evaluated as acceptable.

3 points: Hard texture is felt when biting into the chocolate.

2 points: Hard texture is felt, although teeth easily go through when biting into the chocolate.

1 point: The chocolate felt soft when bitten.

### Evaluation Criteria for Stickiness

The heat resistance of the produced chocolates was evaluated according to the following evaluation criteria. 2 points or more were evaluated as acceptable.

3 points: After storage at 25° C. for 2 hours, the dough does not stick to finger when touched.

2 points: After storage at 25° C. for 2 hours, the dough is soft to a degree that a touch by finger leaves a fingerprint.

1 point: After storage at 25° C. for 2 hours, the dough is soft and adheres to finger when touched.

### Flavor Evaluation Criteria

Flavor of the produced chocolates was evaluated in accordance with the following evaluation criteria. 2 points or more were evaluated as acceptable.

3 points: Chocolate-like flavor is felt abundantly.

2 points: Chocolate-like flavor is felt.

1 point: No chocolate-like flavor is felt at all.

### Evaluation Criteria for Bloom

The prepared chocolates were subjected to a bloom evaluation according to the following evaluation criteria. 2 points or more were evaluated as acceptable.

2 points: Bloom occurrence is not observed, after a storage at 20° C. for 2 months.

1 points: Bloom occurrence is observed, after a storage at 20° C. for 2 months.

TABLE 5

| | Initial | Sticki- | | Bloom | Overall |
|---|---|---|---|---|---|
| | bite | ness | Flavor | resistance | evaluation |
| Example 5 | 2 | 2 | 3 | 2 | ◯ |
| Example 6 | 3 | 3 | 2 | 2 | ⊚ |
| Example 7 | 2 | 2 | 3 | 2 | ◯ |
| Example 8 | 3 | 3 | 2 | 2 | ⊚ |
| Comparative Example 5 | 1 | 2 | 3 | 2 | X |
| Comparative Example 6 | 1 | 1 | 3 | 2 | X |
| Comparative Example 7 | 2 | 1 | 1 | 1 | X |
| Comparative Example 8 | 1 | 1 | 1 | 2 | X |

### Discussion on Table 5

In Examples 5 to 8, all of the hardness at initial bite, the stickiness resistance, the flavor, and the bloom resistance were good, scoring equal to or more than the standard.
In Comparative Examples 5 to 8, one or more of the hardness at initial bite, the stickiness resistance, the flavor, and the bloom resistance were defective, scoring less than the criteria.

### INDUSTRIAL APPLICABILITY

According to the present invention, it is possible to obtain an oil and/or fat composition for chocolate having a hardness at initial bite, a stickiness resistance, a good flavor, and a bloom resistance, and the oil and/or fat composition for chocolate of the present invention can be suitably used in oil-based foods which used these oils and/or fats, particularly in chocolates which are not subjected to a tempering operation.

1. An oil and/or fat composition for chocolate, comprising a randomized triglyceride composition and satisfying all of (A) to (H):
(A) a content of a saturated fatty acid having from 6 to 18 carbons is 80 mass % or more in a constituent fatty acid composition;
(B) a content of lauric acid is from 30 to 45 mass % in a constituent fatty acid composition;
(C) a content of behenic acid is from 0.5 to 5.5 mass % in a constituent fatty acid composition;
(D) a content of an unsaturated fatty acid is 15 mass % or less in a constituent fatty acid composition;
(E) a content of a trans fatty acid is 5 mass % or less in a constituent fatty acid composition;
(F) a palmitic acid content/stearic acid content ratio is from 0.2 to 2 in a constituent fatty acid composition;
(G) an unsaturated fatty acid content/behenic acid content ratio is 4 or less in a constituent fatty acid composition; and
(H) an SFC at 10° C. is 90% or more.

2. The oil and/or fat composition for chocolate according to claim 1, further comprising an extremely hardened high-erucic-acid rapeseed oil.

3. (canceled)

4. The oil and/or fat composition for chocolate according to claim 1, wherein an SFC at 35° C. is 15% or less, and an SFC at 40° C. is 5% or less.

5. The oil and/or fat composition for chocolate according to claim 2, wherein an SFC at 35° C. is 15% or less, and an SFC at 40° C. is 5% or less.

6. (canceled)

7. A method for manufacturing the oil and/or fat composition for chocolate according to claim 1, the method comprising a step of interesterifying a raw material oil and/or fat comprising, as essential components, an oil and/or fat component X, an oil and/or fat component Y, and an oil and/or fat component Z, wherein:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof; and
the oil and/or fat component Z is an extremely hardened high-erucic-acid rapeseed oil.

8. A method for manufacturing the oil and/or fat composition for chocolate according to claim 2, the method comprising a step of interesterifying a raw material oil and/or fat comprising, as essential components, an oil and/or fat component X, an oil and/or fat component Y, and an oil and/or fat component Z, wherein:
the oil and/or fat component X is one or more kinds of oils and/or fats selected from palm kernel oil and a processed oil and/or fat thereof;
the oil and/or fat component Y is one or more kinds of oils and/or fats selected from palm oil and a processed oil and/or fat thereof; and
the oil and/or fat component Z is an extremely hardened high-erucic-acid rapeseed oil.

9. (canceled)

10. (canceled)

11. A method for manufacturing the oil and/or fat composition for chocolate according to claim 1, the method comprising a step of interesterifying a raw material oil and/or fat comprising, as essential components, an oil and/or fat component X, an oil and/or fat component Y, and an oil and/or fat component Z, wherein:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

12. A method for manufacturing the oil and/or fat composition for chocolate according to claim 2, the method comprising a step of interesterifying a raw material oil and/or fat comprising, as essential components, an oil and/or fat component X, an oil and/or fat component Y, and an oil and/or fat component Z, wherein:
the oil and/or fat component X is palm kernel oil and/or highly hardened palm kernel oil;
the oil and/or fat component Y is one or more kinds of oils and/or fats selected from palm oil, high melting point part of fractionated palm, and extremely hardened palm oil;
the oil and/or fat component Z is an extremely hardened high-erucic-acid rapeseed oil.

13. (canceled)

14. (canceled)

15. A chocolate comprising the oil and/or fat composition for chocolate according to claim 1.

16. A chocolate comprising the oil and/or fat composition for chocolate according to claim 2.

17. (canceled)

18. (canceled)
